(19) United States
(12) Patent Application Publication
(10) Pub. No.: US 2009/0287917 A1
(43) Pub. Date: Nov. 19, 2009

(54) SECURE SOFTWARE DISTRIBUTION

(75) Inventors: Todd Carpenter, Monroe, WA (US); David Abzarian, Kirkland, WA (US); Mark Myers, Fall City, WA (US); David James Foster, Bellevue, WA (US); Teddy Liu, Singapore (SG); Ethan Toon Wu Ang, Singapore (SG); Suzie Mitchell, Singapore (SG)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/122,747

(22) Filed: May 19, 2008

(51) Int. Cl. G06F 9/445; H04L 9/32; G06F 9/24

(52) U.S. Cl. 713/2; 726/16; 717/174

(57) ABSTRACT

To protect against software piracy, a storage media has a cryptographically protected area that stores software to be installed onto a target device, such as a computer. The storage media may include a non-secure area holding boot files and an installation program. The installation program may gather target device-specific data for use by a certifying authority in generating a key that allows access to the secure area of the storage media only during the installation process. In this manner, a user never has access to the raw installation files, limiting the ability to copy and distribute those files for installation on non-authorized computers. The certifying authority may also prepare target device-specific data applied to the software before installation to create a custom software image that will only execute on the target device and that can be verified by the host OS prior to execution, allowing integrity confirmation.

### BACKGROUND

Distribution of software on magnetic or optical rotating media has been the typical method of choice almost since the beginning of the PC era. Several side effects of such distribution occur. First, the installation software, including any code to be installed, is visible to any user with access to the media. This allows duplication of the media and/or execution of the installation process on multiple computers or other target devices. Second, the software can be installed on as many target devices as have access to either the original media or a copy of the software from the original media. In some environments, this poses a significant exposure to a software publisher. Post-installation activation techniques can limit piracy due to multiple installations but do not protect against installation and beneficial use for at least a limited time.

Dongles have been used for piracy prevention, but are required each time the installed software is executed, affecting performance, and have themselves been copied.

### SUMMARY

A smart storage media cryptographically protects target software from access or inspection other than during a validated installation process. The smart storage media cannot be copied because a protected front end does not allow access to the actual contents unless an authorization process has been completed. The authorization process may require that no other user processes are active when the smart storage media is opened.

The smart storage media may also collect computer or other target device-specific data that is sent to a service for validation. The service may return an authorized product identifier that is personalized for the specific computer. This not only allows installation only to the specific computer, but also allows personalization of the software so that it will operate only on that specific computer.

After the initial installation, the personalized product identifier may allow the software itself to confirm that it is running on the computer for which it was intended, by comparing the computer-specific data signed by the service with locally generated computer-specific data.

Additionally, the service may modify a copy of the software being installed with the computer-specific data, take a hash of the modified copy, sign the hash and return it to the target computer. Back on the target computer, the installation program may make a similar modification to its local copy of the software being installed. Whenever the software is executed, the computer may validate software using the hash received from the service. When all aspects are implemented, the computer can validate that it is running authorized code and the software can confirm that it is running on the machine for which it was intended. Further, the storage media protects the raw software from non-authorized access.

### BRIEF DESCRIPTION OF THE DRAWINGS

FIG. 1 is a block diagram of a general purpose computing device in communication with a storage media;

FIG. 2 is a block diagram of an exemplary storage media;

FIG. 3 is a flow chart of a method of installing a software executable; and

FIG. 4 is a flow chart of a method of controlling access to an installed software executable.

### DETAILED DESCRIPTION

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts in accordance to the present invention, further discussion of such software and ICs, if any, will be limited to the essentials with respect to the principles and concepts of the preferred embodiments.

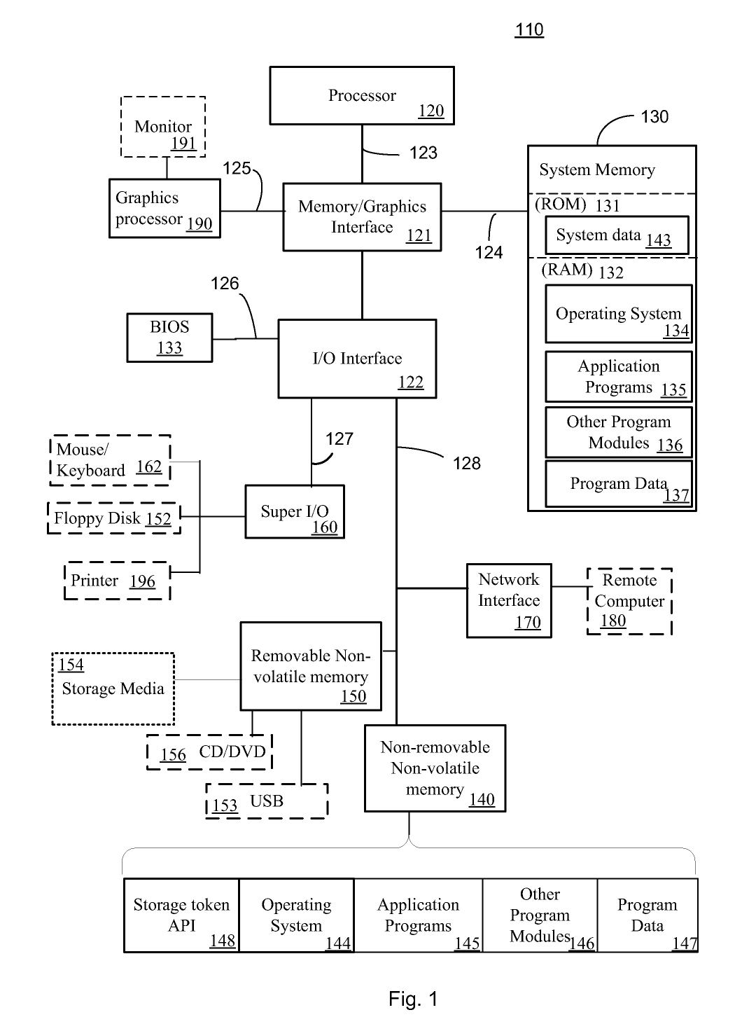

With reference to FIG. 1, an exemplary system for implementing the claimed method and apparatus includes a general purpose computing device in the form of a computer 110. Components shown in dashed outline are not technically part of the computer 110, but are used to illustrate the exemplary embodiment of FIG. 1. Components of computer 110 may include, but are not limited to, a processor 120, a system memory 130, a memory/graphics interface 121, known as a Northbridge chip, and an I/O interface 122, also known as a Southbridge chip. The system memory 130 and a graphics processor 190 may be coupled to the memory/graphics interface 121. A monitor 191 or other graphic output device may be coupled to the graphics processor 190.

A series of system busses may couple various system components including a high speed system bus 123 between the processor 120, the memory/graphics interface 121 and the I/O interface 122, a front-side bus 124 between the memory/graphics interface 121 and the system memory 130, and an advanced graphics processing (AGP) bus 125 between the memory/graphics interface 121 and the graphics processor 190. The system bus 123 may be any of several types of bus structures including, by way of example, and not limitation, such architectures include Industry Standard Architecture (ISA) bus, Micro Channel Architecture (MCA) bus and Enhanced ISA (EISA) bus. As system architectures evolve, other bus architectures and chip sets may be used but often generally follow this pattern. For example, companies such as Intel and AMD support the Intel Hub Architecture (IHA) and the HyperTransport™ architecture, respectively.

The computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 1 10.

The system memory 130 includes computer storage media in the form of volatile and/or nonvolatile memory such as read only memory (ROM) 131 and random access memory (RAM) 132. The system ROM 131 may contain permanent system data 143, such as identifying and manufacturing information. In some embodiments, a basic input/output system (BIOS) may also be stored in system ROM 131. RAM 132 typically contains data and/or program modules that are immediately accessible to and/or presently being operated on by processor 120. By way of example, and not limitation, FIG. 1 illustrates operating system 134, application programs 135, other program modules 136, and program data 137.

The I/O interface 122 may couple the system bus 123 with a number of other busses 126, 127 and 128 that couple a variety of internal and external devices to the computer 110. A serial peripheral interface (SPI) bus 126 may connect to a basic input/output system (BIOS) memory 133 containing the basic routines that help to transfer information between elements within computer 110, such as during start-up.

A super input/output chip 160 may be used to connect to a number of ‘legacy’ peripherals, such as floppy disk 152, keyboard/mouse 162, and printer 196, as examples. The super I/O chip 160 may be connected to the I/O interface 122 with a bus 127, such as a low pin count (LPC) bus, in some embodiments. Various embodiments of the super I/O chip 160 are widely available in the commercial marketplace.

In one embodiment, bus 128 may be a Peripheral Component Interconnect (PCI) bus, or a variation thereof, may be used to connect higher speed peripherals to the I/O interface 122. A PCI bus may also be known as a Mezzanine bus. Variations of the PCI bus include the Peripheral Component Interconnect-Express (PCI-E) and the Peripheral Component Interconnect-Extended (PCI-X) busses, the former having a serial interface and the latter being a backward compatible parallel interface. In other embodiments, bus 128 may be an advanced technology attachment (ATA) bus, in the form of a serial ATA bus (SATA) or parallel ATA (PATA).

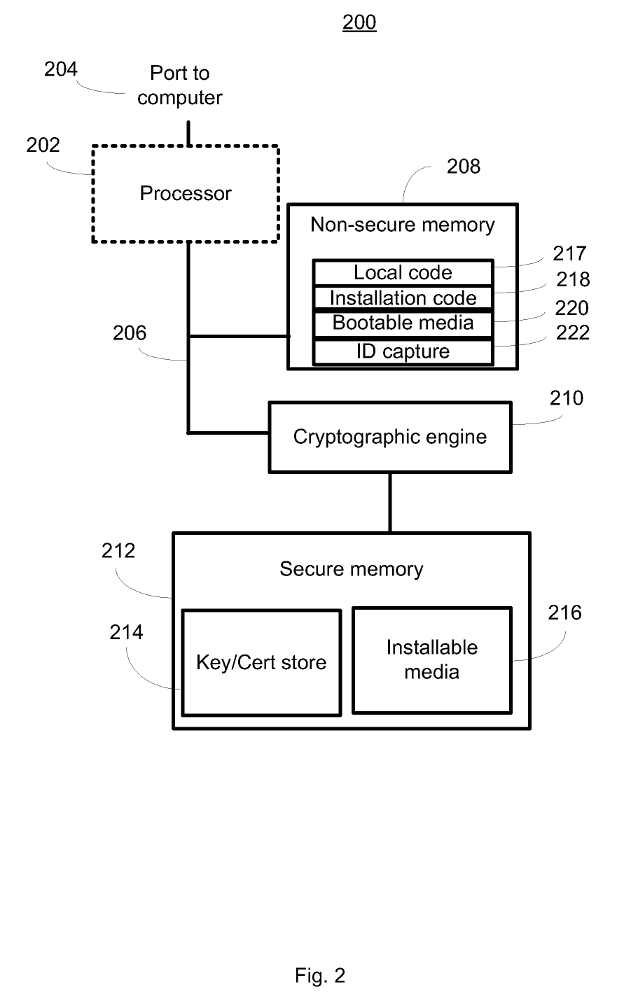

The computer 110 may also include other removable/non-removable, volatile/nonvolatile computer storage media. By way of example only, FIG. 1 illustrates a hard disk drive 140 that reads from or writes to non-removable, nonvolatile magnetic media. The hard disk drive 140 may be a conventional hard disk drive or may be similar to the storage media described below with respect to FIG. 2.

Removable media, such as a universal serial bus (USB) memory 153, firewire (IEEE 1394), or CD/DVD drive 156 may be connected to the PCI bus 128 directly or through an interface 150. A storage media 154 similar to that described below with respect to FIG. 2 may coupled through interface 150. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

The drives and their associated computer storage media discussed above and illustrated in FIG. 1, provide storage of computer readable instructions, data structures, program modules and other data for the computer 110. In FIG. 1, for example, hard disk drive 140 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a mouse/keyboard 162 or other input device combination. Other input devices (not shown) may include a microphone, joystick, game pad, satellite dish, scanner, or the like. These and other input devices are often connected to the processor 120 through one of the I/O interface busses, such as the SPI 126, the LPC 127, or the PCI 128, but other busses may be used. In some embodiments, other devices may be coupled to parallel ports, infrared interfaces, game ports, and the like (not depicted), via the super I/O chip 160.

The computer 110 may operate in a networked environment using logical connections to one or more remote computers, such as a remote computer 180 via a network interface controller (NIC) 170. The remote computer 180 may be a personal computer, a server, a router, a network PC, a peer device or other common network node, and typically includes many or all of the elements described above relative to the computer 110. The logical connection between the NIC 170 and the remote computer 180 depicted in FIG. 1 may include a local area network (LAN), a wide area network (WAN), or both, but may also include other networks. Such networking environments are commonplace in offices, enterprise-wide computer networks, intranets, and the Internet. The remote computer 180 may also represent a web server supporting interactive sessions with the computer 110.

In some embodiments, the network interface may use a modem (not depicted) when a broadband connection is not available or is not used. It will be appreciated that the network connection shown is exemplary and other means of establishing a communications link between the computers may be used.

A storage media 154 may be permanently or removably attached to the computer 110. The connection may be either wired or wireless. The storage media 154 may be a smart card or other device capable of cryptographic one-way or mutual authentication between itself and one or more processes on the computer 110 or remote computer 180. Alternately, the storage media may be a primary fixed disk drive, such as drive hard disk drive 140.

FIG. 2 is block diagram of a storage media 200 suitable for use in secure software distribution. The storage media 200 may include a processor 202 or data management module that performs standard functions, such as, physical line interfacing, protocol management, inbound and outbound data buffering, data caching, etc. The processor 202 or data management module may be particularly present in embodiments where the storage media 200 is a disk drive or removable storage token, such as a USB memory. In other embodiments, the processor 202 may not be present. For example, access to a cryptographic engine 210 may be accomplished through registers or other memory-mapped mechanisms.

The storage media 200 may also include a port 204 for coupling to a host computer or other target device, such as computer 110 of FIG. 1, either as in internal component, such as hard disk drive 140 of FIG. 1, or as a removable component via a connection to an interface within a computer, such as interface 150. The host device may be a computer, such as computer 110 of FIG. 1, or another electronic device, such as a cellular telephone, personal digital assistant, smart phone, media player, game system, etc.

The storage media 200 may have an internal bus 206 that connects the processor 202 or data management module to a non-secure memory 208 and the cryptographic engine 210. A secure memory 212 may be accessed via the cryptographic engine 210 and may store not only keys and certificates 214, but also installable media 216. The installable media 216 may be a utility, an application, a operating system, etc. The installable media 216 may be a memory image that can be permanently installed on the computer and executed from there, or may be executed from within the secure memory 212 each time it is needed.

The non-secure memory 208 may include various settings and executable code modules. For example, the non-secure memory 208 may have local executable code 217, that may be used by the processor 202, when present, to support local operations on the storage media 200. The non-secure memory 208 may also include code that may be executed on a host computer, such as an installation program 218 or an installation tool, bootable media 220, and identification capture code 222, or identification capture module.

The installation program 218 may be executed to manage the process of opening the secure memory 212 and installing the installable media 216.

The bootable media 220 may be used during the boot cycle of the computer 110 to provide a known boot environment, although in some circumstances, this may not be required. When installing an operating system, especially on a new computer, the bootable media 220 may be the only available boot code.

The identification capture program 222 may be used to search for and return various indices that help to uniquely identify the computer 110. Such identifiers may include a processor serial number, a network interface card media access control (MAC) number, a main board serial number, etc. The one or more numbers that are gathered may be used separately, or in combination, to create an identifier that may be used repeatedly throughout the life of the computer 110. Therefore, the identification capture program 222 should only collect that information that will be available not only over the life of the computer but also early in the boot cycle.

The configuration depicted in FIG. 2 may be logical only. That is, even though the full, unrestricted access may be allowed to the non-secure memory 208, it may be accessed via the cryptographic engine 210.

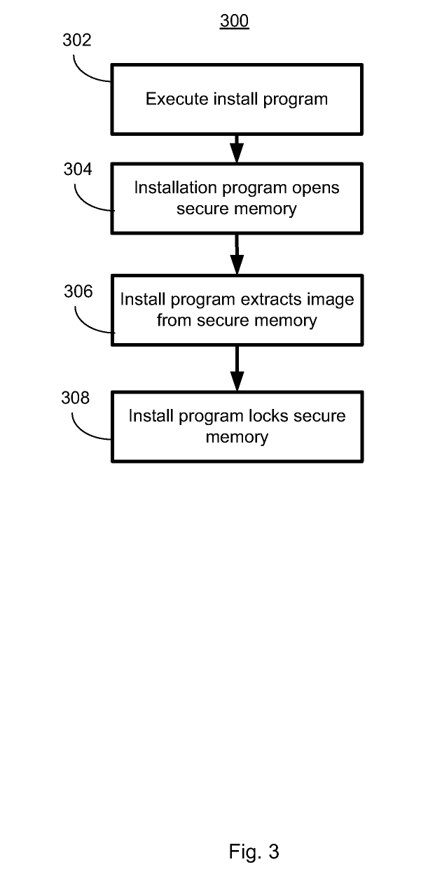

FIG. 3 is a method 300 of secure software distribution. At block 302, an installation program 218 may be loaded from the non-secure memory 208 and executed to begin an installation process.

At block 304, the installation program 218 may open the secure memory. The installation program may ask a user for a product code or other identifier that is used to unlock the secure memory. Alternatively, the user may contact a web site to download a key, for example, after payment of a license fee, and receive the key through the web site or via an email. The product code, in this simple embodiment, may be a signed product serial number. The product serial number may be stored in the secure memory 212. A public key used to verify the signature may be stored in the key and certificate store 214. If public key is be stored in a certificate, the certificate may be stored in the non-secure memory 208. After the installation program has presented proper credentials and the cryptographic engine 210 has verified those credentials, the installation program 218 may be given access to the secure memory 212, and particularly, to the installable media 216.

To reinforce the secure nature of the installation process, the installation program 218 may confirm that no other programs are running or take other steps to insure that it has exclusive access to the secure memory 212 during the period when the secure memory is open.

At block 306, the installation program 218 may extract the installable media 216 from the secure memory 212. The installation program 218 may take those steps normally associated with installation of a program, for example, updating registry entries, if appropriate, setting user preferences and adjusting the operational environment, for example, language and time zone settings. The installation program 218 may confirm that an image is correctly created in the computer 110 and end the installation process.

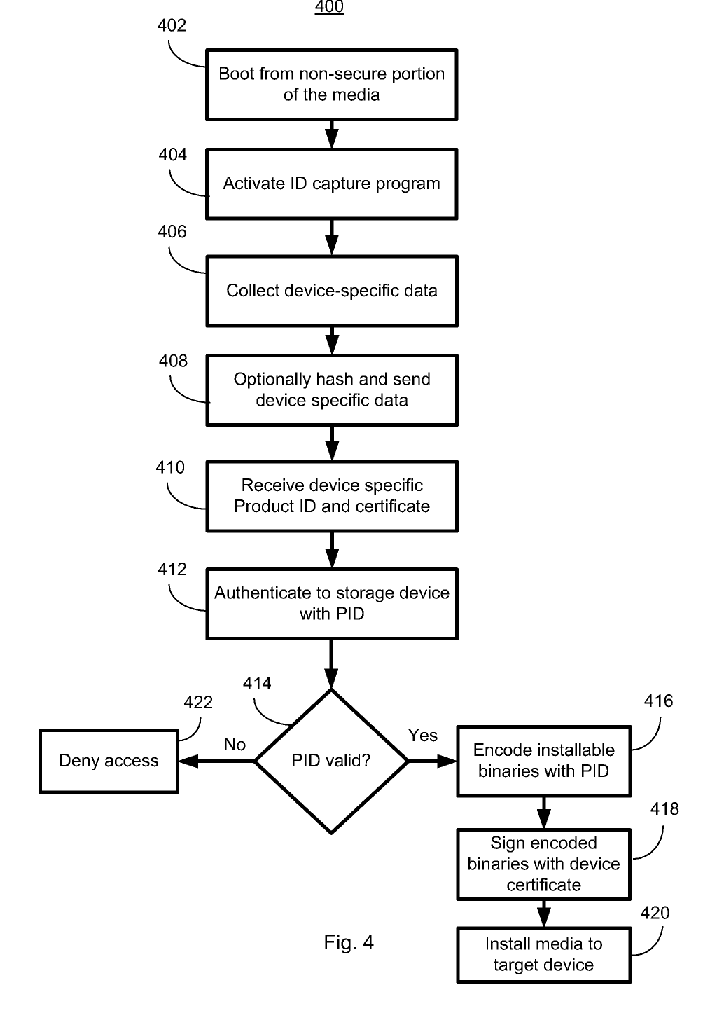

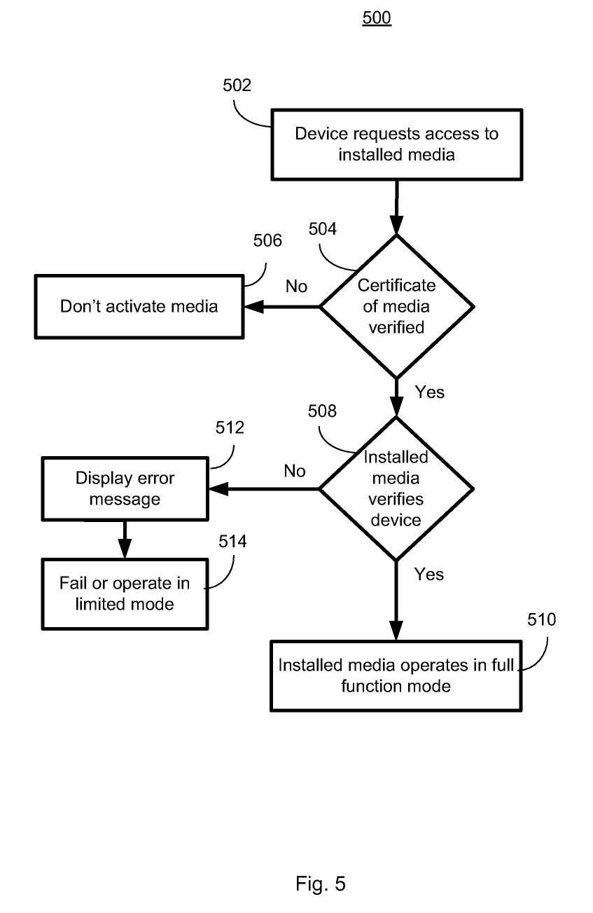

At block 308, the installation program 218 may signal the cryptographic engine 210 to lock the secure memory 212. If the installation was related to installation of an operating system or some other applications, a reboot may be required. The storage media 200 may support other installation processes, as illustrated by the exemplary process of FIG. 4.

FIG. 4 is a method 400 of using a storage media, such as storage media 200, to support a secure installation process that limits access to the program or memory image to be installed on a computer, such as computer 110.

At block 402, the computer 110 may boot from a non-secure memory 208 of the storage media 200. Bootable media 220 may be used to for booting, so that a known boot environment is provided. Starting the computer 110 from the bootable media 220 may also help ensure that no other, potentially malicious programs are running.

At block 404, an identification capture program 222 may be executed by either the bootable media 220 or an installation program 218. At block 406, the identification capture program 222 may collect computer-specific data or statistics about the computer 110 that may be used to identify the computer, both during the initial installation program and throughout the life of the computer. For example, such identifiers may include a unique computer or processor identifier, a basic input output system (BIOS) identifier, or one or more component serial numbers.

At block 408, the computer-specific data may be sent to a certifying authority, validation service, or other authorized party in the distribution chain of the installable media 216. In other embodiments, the computer-specific data may be hashed before sending to the certifying authority. As is known, hashing creates a consistent size value that remains statistically unique for the purpose of identifying the computer.

At block 410, the computer 110 may receive back a computer-specific product identifier (ID). The computer-specific product identifier may be derived from a combination of an identifier of the product being installed (e.g. a model number) and the computer-specific data. The computer-specific product ID may optionally be packaged in a certificate, signed by the certifying authority's private key and containing the certifying authority's public key, if such as public key is not already in the possession of the storage media 200.

In another embodiment, the certifying authority may also embed, e.g. append, the computer-specific data (or its hash) into a server copy of the installable media. The certifying authority may then hash the installable media with the computer-specific data (or its hash), sign the resulting authentication value and return it to the computer 110. The computer's use of this additional data that may be returned from the certifying authority is discussed in more detail below and with respect to FIG. 5.

At block 412, the cryptographic engine 210 may authenticate the signature of the returned computer-specific product identifier. At block 414, when the signature is valid, the cryptographic engine 210 may confirm that the signed computer-specific product identifier corresponds to the computer-specific data by generating a new computer-specific data product identifier using the same process as followed at the certifying authority and performing a comparison. If the comparison is successful, the ‘yes’ branch from block 414 may be followed to block 416.

At block 416, the installable media 216 may be modified with the computer-specific data using the same process followed at the certifying authority to generate a version of the installable media 216 modified with computer-specific data.

At block 418, a hash of the modified installable media may be taken to generate a new authentication value that may be confirmed by comparison to the authentication value received from the certifying authority. When the comparison succeeds, operation may continue at block 420.

At block 420, the installable media 216, as modified by the computer-specific data may be installed to the target electronic device, e.g. computer 110.

If, at block 414, the computer-specific product identifier does not contain valid product data or valid computer-specific data, the ‘no’ branch from block 414 may be taken to block 422. At block 422, access to the secure memory 212, and therefore, the installable media 216, may be denied.

FIG. 5 illustrates a method 500 of activating code on a computer, such as computer 110, when the code is installed following the process of FIG. 4.

At block 502, the computer 110, for example, in the form of a boot loader, may request access to the installed media.

At block 504, the signed computer-specific product identifier received from the certifying authority may be verified by measuring the installed media and generating a new computer-specific product identifier. The new and signed computer-specific product identifiers match, the ‘yes’ branch to block 508 may be followed.

If the new and signed computer-specific product identifiers do not match, indicating, in some cases, tampering, the ‘no’ branch from block 504 may be followed to block 506 and the installed media may not be started.

When the ‘yes’ branch from block 504 is followed, that indicates that the computer 110 can trust the integrity of the installed media. At block 508, the installed media, during its initial activation process may measure the computer by gathering the computer-specific data, combining it with product information and comparing it to the signed version of the computer-specific product identifier received from the certifying authority. If the comparison succeeds, the installed media can trust that it is operating in the target device for which it was intended and the ‘yes’ branch may be taken to block 510.

At block 510, the installed media may be operation in a fully functional mode.

If, at block 508, the comparison fails, the ‘no’ branch from block 508 may be followed to block 512. At block 512, the installed media may display an error message. The error message may indicate that the installed media cannot verify its operating environment and refer to a help line or site to which the user may be referred.

Execution may continue at block 514, where the installed media may operate in a limited function mode, or simply quit. By operating in a limited function mode, particularly in the case of an operating system, a user may be given access to a web site where the problem may be diagnosed. If the installed media was moved to another computer, re-licensing may allow a return to full functionality. However, if changes to the physical computer caused a computer-specific data-related failure, presentation of proper credentials may allow the certifying authority to reset the computer-specific product identifier to restore full function. Additionally, while in the limited function mode, the installed media may be able to download an update when in contact with the certifying authority or other authentication-capable site. The update may be a common update related to features and functions or may be update related to security features, such as measurement data or measurement targets.

As an example of another application of such a technique, an application program could be purchased and downloaded at, for example, a vending machine. Separate from the application program, an authorization code could also be downloaded. The storage media could then be attached to a target computer and the transaction verified via the certifying authority. This would allow a user to anonymously purchase an activation code that is later tied to a specific computer. Since the target machine computer-specific data may be hashed, the identity of the target machine may be protected, while the software license is still restricted to use by that machine. In this embodiment only the activation code may be modified with a computer-specific product identifier. When starting, the activation code itself may be measured and verified for use with its target computer and authorized application program. In this fashion, the base code may be used on more than one computer, as long as each computer has a separate activation code, modified with its own computer-specific product identifier.

The storage media and method described above solve a longstanding problem of software piracy through simply copying of the distribution media. The storage media disclosed above addresses such an issue by simply not allowing user processes access to the actual memory image of the code to be installed.

The further use of a certifying authority to create a validated copy of the installed media, and further, to allow the installed media to validate its operating environment further protect the value of investments made by manufacturers and software distributors. When the computer can validate the correctness of the software being executed, the value of the user's investment in a safe operating environment is also enhanced.

Although the foregoing text sets forth a detailed description of numerous different embodiments of the invention, it should be understood that the scope of the invention is defined by the words of the claims set forth at the end of this patent. The detailed description is to be construed as exemplary only and does not describe every possibly embodiment of the invention because describing every possible embodiment would be impractical, if not impossible. Numerous alternative embodiments could be implemented, using either current technology or technology developed after the filing date of this patent, which would still fall within the scope of the claims defining the invention.

Thus, many modifications and variations may be made in the techniques and structures described and illustrated herein without departing from the spirit and scope of the present invention. Accordingly, it should be understood that the methods and apparatus described herein are illustrative only and are not limiting upon the scope of the invention.

We claim:

1. A storage media adapted for secure storage of installation software supporting installation of a software executable on a target device comprising:
a non-secure memory;
a port for communication with the target device coupled directly to the non-secure memory;
a secure memory storing the installation software; and
a cryptographic engine coupled between the port and the secure memory, wherein access to the secure memory is controlled by the cryptographic engine.

2. The storage media of claim 1, further comprising a processor and a data bus, the data bus connecting the processor to the non-secure memory and the cryptographic engine.

3. The storage media of claim 2, wherein the non-secure memory comprises local code for execution by the processor.

4. The storage media of claim 1, wherein the non-secure memory stores an identification capture module that identifies target machine-specific indices for use in modifying the software executable prior to installation on the target device.

5. The storage media of claim 1, wherein the secure memory stores cryptographic keys and the installation software.

6. A method of installing a software executable on an electronic device from a storage media comprising:
identifying an electronic device-specific data corresponding to an identity of the electronic device;
sending a form of the electronic device-specific data to a validation service;
receiving a cryptographic element from the validation service, the cryptographic element related to the form of the electronic device-specific data;
unlocking a secure area of the storage media using the cryptographic element;
installing software from the secure area of the storage media;
locking the secure area of the storage media.

7. The method of claim 6, booting the electronic device from the storage media that is removably attached to the electronic device.

8. The method of claim 7, wherein booting comprises booting from a non-secure memory area of the storage media.

9. The method of claim 6, further comprising:
loading an installation program from the storage media; and
executing the installation program that identifies the electronic device-specific data and communicates with the validation service.

10. The method of claim 6, wherein sending the form of the electronic device-specific data comprises creating a first hash of the electronic device-specific data and sending the first hash to the validation service.

11. The method of claim 10, wherein receiving the cryptographic element comprises receiving a signed first hash of the electronic device-specific data.

12. The method of claim 11, further comprising embedding the signed first hash of the electronic device-specific data in the software executable; and
validating a computed hash of the electronic device-specific data against the signed first hash prior to operation of the software executable.

13. The method of claim 10, wherein receiving the cryptographic element comprises receiving a second hash computed using the software executable and the first hash.

14. The method of claim 10, further comprising:
receiving a signed digest of the software executable modified by embedding the first hash of the electronic device-specific data;
modifying a local copy of the software executable by embedding the first hash of the electronic device-specific data; and
verifying, by an operating system of the electronic device, the signed digest of the software executable against a computed digest of the software executable prior to executing the software executable.

15. The method of claim 14, wherein receiving the signed digest of the software executable comprises receiving the signed digest of the software executable from the validation service.

16. A method of managing software installs on a computer using a storage media and a validation service comprising:
loading a software program for installation on the computer onto a secure memory of the storage media;
installing a public key associated with the validation service in the secure memory of the storage media;
loading an installation tool onto a non-secure memory of the storage media;
coupling the storage media to the computer;
executing the installation tool;
collecting at least one computer-specific identifier;
establishing communication between the computer and the validation service;
sending a value corresponding to the at least one computer-specific identifier to the validation service;
performing a modifying operation on a copy of the software program at the validation service using the value;
receiving from the validation service a signed version of the value, a signed hash of the software program incorporating the value, and a signed key, wherein the signed version of the value, the signed hash of the software program incorporating the value, and the signed key are each signed by a private key of the validation service;
presenting the signed key to a cryptographic engine of the storage media;
allowing the installation tool access to the software program when the signed key is verified by the cryptographic engine;
modifying the software program using the value in a manner corresponding to the modifying operation performed at the validation service;
installing the software program onto the computer;
verifying, prior to executing the software program, a local hash of the software program incorporating the value by comparing the local hash to the signed hash of the software program incorporating the value;
executing the software program; and
verifying, at the software program, the at least one computer-specific identifier using the signed version of the value received from the validation service.

17. The method of claim 16, further comprising booting the computer from a a boot module on the non-secure memory of the storage media.

18. The method of claim 16, wherein establishing communication comprises one of establishing a real-time network connection and establishing a path for electronic mail.

19. The method of claim 16, wherein collecting computer-specific identifiers comprises at least two of a motherboard serial number, a processor serial number, a peripheral serial number, a support chip serial number, and a network card media access control (MAC) address.

20. The method of claim 16, further comprising, hashing the at least one computer-specific identifier to generate the value corresponding to the at least one computer-specific identifier.
